(19) United States
(12) Patent Application Publication
(10) Pub. No.: US 2021/0248362 A1
(43) Pub. Date: Aug. 12, 2021

(54) IMAGE-RECOGNITION-BASED CONTROL METHOD AND APPARATUS, AND CONTROL DEVICE

(71) Applicant: SZ DJI TECHNOLOGY CO., LTD., Shenzhen (CN)

(72) Inventors: Lei PANG, Shenzhen (CN); Weixing ZHANG, Shenzhen (CN); Zheng KUANG, Shenzhen (CN)

(21) Appl. No.: 17/242,277

(22) Filed: Apr. 27, 2021

Related U.S. Application Data
(63) Continuation of application No. PCT/CN2018/113160, filed on Oct. 31, 2018.

(51) Int. Cl. G06K 9/00; G06K 9/62; G06T 7/50; G06T 7/73; G06T 3/40; G06K 9/20; F41A 17/08; G06N 20/00; G06N 5/04

(52) U.S. Cl. CPC G06K 9/00369; G06K 9/6256; G06T 7/50; G06T 7/73; G06T 3/40; G06K 9/2054; G06K 2209/21; F41A 17/08; G06N 20/00; G06N 5/04; G06T 2207/30196; G06T 2207/10048; G06K 9/209

(57) ABSTRACT

An image-recognition-based control method includes calling an imaging device of a shooting device to collect an environment image of an environment where the shooting device is currently located; calling a preset human-body-feature-part detection model to perform image area identification on the environment image to provide an identification result; and prohibiting a shooting member of the shooting device from shooing, in response to the identification result indicating that the environment image contains a target image area including a preset human-body-feature-part.

### CROSS-REFERENCE TO RELATED APPLICATION

This application is a continuation of International Application No. PCT/CN2018/113160, filed on Oct. 31, 2018, the entire content of which is incorporated herein by reference.

### TECHNICAL FIELD

The present disclosure relates to the technical field of image processing and, more specifically, to an image-recognition-based control method and apparatus, and a control device.

### BACKGROUND

Shooting devices (such as shooting toy products) have been popular among users. During the use of these shooting devices, some users may make wrong estimates of the power of the shooting devices, which often causes the shooting device to shoot at a certain part of the human body, resulting in injury incidents. Therefore, in the process of using shooting devices, there is a need to provide methods, apparatus and devices to prevent shooting devices from shooting at certain parts of the human body.

### SUMMARY

One aspect of the present disclosure provides a control method based on image recognition, including: calling an imaging device of a shooting device to collect an environment image of an environment where the shooting device is currently located; calling a preset human-body-feature-part detection model to perform image area identification on the environment image to provide an identification result; and prohibiting a shooting member of the shooting device from shooing, in response to the identification result indicating that the environment image contains a target image area including a preset human-body-feature-part.

Another aspect of the present disclosure provides a control apparatus, configured in a shooting device. The control apparatus includes a communication interface; and a controller, the controller being configured to: call an imaging device of the shooting device to collect an environment image of an environment where the shooting device is currently located; call a preset human-body-feature-part detection model to perform image area identification on the environment image to provide an identification result; and prohibit a shooting member of the shooting device from shooing in response to the identification result indicating that the environment image contains a target image area including a preset human-body-feature-part.

Additional aspects and advantages of the technical solutions of the present disclosure will be partially provided in the following descriptions, and partially become obvious from the following descriptions. Alternatively, the additional aspects and advantages of the technical solutions can be understood from practicing the various embodiments of the present disclosure.

### BRIEF DESCRIPTION OF THE DRAWINGS

In order to illustrate the technical solutions in accordance with the embodiments of the present disclosure more clearly, the accompanying drawings to be used for describing the embodiments are introduced briefly in the following. It is apparent that the accompanying drawings in the following description are only some embodiments of the present disclosure. Persons of ordinary skill in the art can obtain other accompanying drawings in accordance with the accompanying drawings without any creative efforts.

FIG. 1A is a schematic structural diagram of a shooting device according to an embodiment of the present disclosure.

FIG. 1B is a schematic diagram of a scenario according to an embodiment of the present disclosure.

FIG. 1C is a schematic diagram of an environment image according to an embodiment of the present disclosure.

FIG. 2 is a flowchart of a control method based on image recognition according to another embodiment of the present disclosure.

FIG. 3 is a schematic diagram of image position information of the head and shoulders in a training image according to an embodiment of the present disclosure.

FIG. 4A is a schematic diagram of a training image according to an embodiment of the present disclosure.

FIG. 4B is a schematic diagram of another training image according to an embodiment of the present disclosure.

FIG. 4C is a schematic diagram of another training image according to an embodiment of the present disclosure.

FIG. 4D is a schematic diagram of another training image according to an embodiment of the present disclosure.

FIG. 5 is a flowchart of another control method based on image recognition according to an embodiment of the present disclosure.

FIG. 6A is a schematic diagram of another environment image according to an embodiment of the present disclosure.

FIG. 6B is a schematic diagram of a first sub-image according to an embodiment of the present disclosure.

FIG. 7 is a flowchart of another control method based on image recognition according to an embodiment of the present disclosure.

FIG. 8 is a flowchart of another control method based on image recognition according to an embodiment of the present disclosure.

FIG. 9 is a schematic structural diagram of a control apparatus based on image recognition according to an embodiment of the present disclosure.

FIG. 10 is a control device according to an embodiment of the present disclosure.

### DETAILED DESCRIPTION OF THE EMBODIMENTS

In order to make the objectives, technical solutions, and advantages of the present disclosure more clear, the technical solutions in the embodiments of the present disclosure will be described below with reference to the drawings. It will be appreciated that the described embodiments are some rather than all of the embodiments of the present disclosure. Other embodiments conceived by those having ordinary skills in the art on the basis of the described embodiments without inventive efforts should fall within the scope of the present disclosure. In the situation where the technical solutions described in the embodiments are not conflicting, they can be combined.

An embodiment of the present disclosure provides a control method based on image recognition. The method can be applied to a shooting device. The shooting device may be a toy product or a competitive robot product, and the shooting device may include a shooting member and an imaging device. The shooting member can achieve the purpose of hitting a target or other competitive robots by shooting soft plastic objects. The imaging device can be used to obtain images of the environment where the shooting device is located, and provide related functions for image collection to automatically control the shooting member for safe shooting.

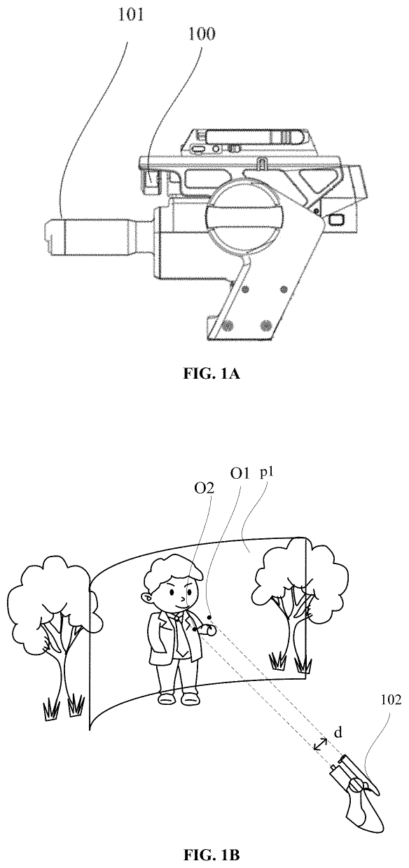

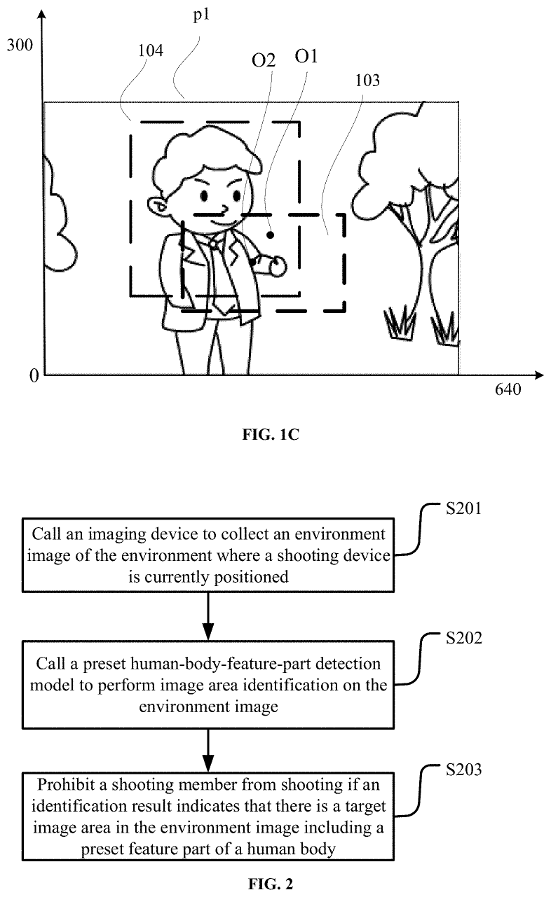

The shooting device can be a handheld standalone device, or it can be disposed devices that require shooting functions, such as unmanned aerial vehicles (UAVs), aerial aircrafts, gimbals, and remote-controlled vehicles. As shown in FIG. 1A, which illustrates a shooting device. The shooting device includes an imaging device 100 and a shooting member 101. It can be seen that the imaging device and the shooting member are both fixed on the main structure of the shooting device. The imaging device 100 is positioned directly above the shooting member 101. The shooting member 101 can be used for shooting processing, such as shooting plastic objects such as BB bullets, water bullets, etc. The imaging device 100 can be used to obtain an environment image directly in front of the shooting member 101 in the environment where the shooting device is currently located.

Referring to FIG. 1B, the shooting device can cause the imaging device to obtain the environment image of the current environment, and the obtained environment image p1 may be as shown in FIG. 1C. FIG. 1C includes an image area 103 (i.e., the shooting image area) corresponding to the shooting estimation area of the shooting member on the environment image p1, a center point O1 of the obtained environment image p1, a center point O2 of the shooting image area, a target image area 104 of the preset feature parts of the human body. The preset feature pats of the human body may be the feature parts of the human body, such as the body, face, or the head and shoulders. Further, after the shooting device obtains the environment image p1, it may cause a preset human-body-feature-part detection module to perform recognition on the image area of p1. If the recognition result indicates that the target image area 104 shown in FIG. 1C is in p1, the shooting member may be controlled to prevent shooting, such as preventing the shooting member from firing bullets. By adopting the technical solutions of the present disclosure, the shooting device can be safety controlled in conjunction with images, thereby preventing the shooting member from shooting at the feature parts of the human body, which is beneficial in improving the safety of the shooting device.

The shooting device 102 in FIG. 1B is merely an example, and the specific structure of the shooting device in the present disclosure is provided in FIG. 1A. At the same time, the shooting device in FIG. 1B is merely an example. In other examples, the shooting device shown in FIG. 1B can also be mounted on competitive robots, UAVs, and other devices, or the shooting device may be a competitive robot, UAV, and other devices with an imaging device and a shooting member. At the same time, FIG. 1B and FIG. 1C are merely examples of scenes involves in the embodiments of the present disclosure, mainly used to illustrate part of the principle of image recognition and shooting control for the safety control of the shooting device based on the imaging device and the shooting member in the embodiments of the present disclosure.

FIG. 2 is a flowchart of a control method based on image recognition according to another embodiment of the present disclosure. The method can be executed by a shooting device, and the method can be applied to a shoot device, the shooting device may include a shooting member and an imaging device.

In the control method based on image recognition shown in FIG. 2, in the process at S201, the shooting device may call the imaging device to collect environment image of the environment where the shooting device is current positioned. In some embodiments, the shooting device may collect the environment image of the environment where the shooting device is currently located through the imaging device at a preset time interval. The preset time interval may be set based on the shooting interval of the shooting member. The shooting interval may be the time between the end time of the last shot of the shooting member and the start time of the current shot. In some embodiments, the preset time interval may be set to be less than the shooting interval, such that the shooting member can be prohibited from performing shooting before the next shooting starts.

After the shooting device calls the imaging device to collect the environment image of the current environment, in the process at S202, a human-body-feature-part detection model can be called to identify the image area of the environment image.

In some embodiments, the human-body-feature-part detection model may include a head and shoulders detection model. When configuring the head and shoulders detection model, the initial detection model can be trained based on the training images in the sample image set and the annotation information of each training image to obtain the head and shoulders detection model. Further, the optimized head and shoulders detection model after training can be added to the shooting device to provide detection of the image area including head and shoulders. In some embodiments, the sample image set may include a plurality of training image groups collected in different shooting scenes. The training images in the training image group may include the image area of the head and shoulders, and the annotation information may include the image position information of the head and shoulders in the corresponding training image.

In some embodiments, the image area corresponding to the head and shoulders may be a rectangular area. In this case, the image position information of the head and shoulders in the training image may include the position information of the upper left corner and the lower right corner of the corresponding image area of the head and shoulders in the training image. The image position information may reflect the specific position of the head and shoulders corresponding image area in the training image, and it may also reflect the size of the head and shoulders corresponding image local area.

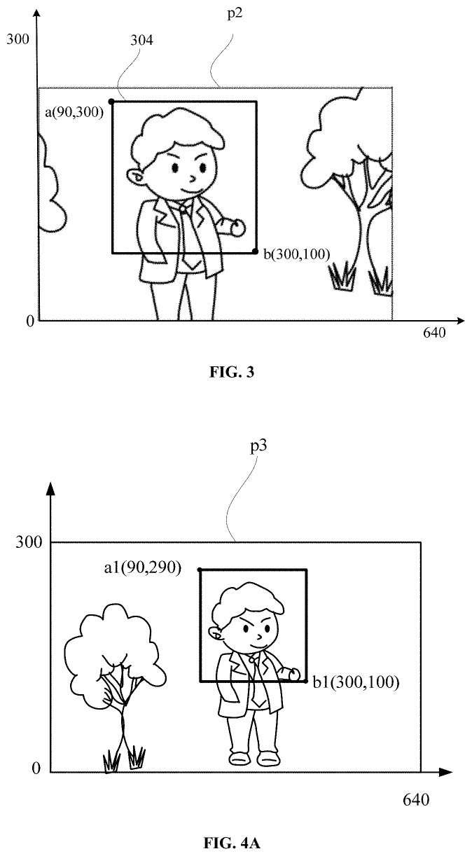

As shown in FIG. 3, the position information of the upper left corner and the lower right corner of the corresponding image area of the head and shoulders in the training image can be the coordinate information of the upper left corner and the coordinate information of the lower right corner, respectively. The training data for detecting the human-body-feature-part detection model includes a training image p2, an image area 304 including the head and shoulders, a point a corresponding to the upper left corner of the image area 304, and a point b corresponding to the lower right corner of the image area 304. The coordinates of point a are (90, 300), and the coordinates of point b are (300, 100). The coordinate information of point a and point b can be used to determine the image area 304 including the head and shoulders in the environment image. In this case, the coordinate information of point a and point b is the image position information of the head and shoulders in the training image.

Alternatively, the image area corresponding to the head and shoulders described above may be an area of other shapes, for example, it may be in the shape of a n-sided (n may be an integer greater than or equal to three). In this case, the image position information may be the coordinate information of the n points corresponding to the n-sided shape. In another example, the image area may be a circle. In this case, the image position information may include the coordinate information of the origin of the circle and the radius of the circle. It should be noted that the shape of the image area is not limited in the embodiments of the present disclosure.

In some embodiments, when configuring the head and shoulders detection model, the shooting scene may include shooting scenes of head and shoulders with different attitudes or different angles under different light (such as backlight or normal light). In one embodiment, a plurality of training images of the side of the head and shoulders taken in a backlight shooting scene can be collected in advance to obtain a first training image group; a plurality of training images of the frontal head and shoulders taken in the backlight shooting scene can be collected to obtain a second training image group; a plurality of training images of the head and shoulders of the lowered head taken in the backlight shooting scene can be collected to obtain a third training image group; a plurality of training images of the frontal head and shoulders taken under normal light can be collected to obtain a fourth training image group; a plurality of training images of the side of the head and shoulders taken under normal light can be collected to obtain a fifth training image group; and a plurality of training images of the back of the head and shoulders taken under normal light can be collected to obtain a sixth training image group. Further, the training images in each training image group can be annotated with the image position information of the head and shoulders, that is, the image position information of the image area including the head and shoulders in the training image can be annotated, and the annotation information corresponding to each training image can be obtained. After obtaining the training image and the annotation information corresponding to the training image, the initial detection model can be trained based on a large number of training images and the annotation information of each training image, and a head and shoulders detection model that can be used to detect the head and shoulders image area can be obtained. The optimized head and shoulder detection model can be added in the corresponding shooting device to provide detection of the head and shoulder image area. In some embodiments, the initial detection model may be an object detection model based on a neural network, and the neural network may be a convolutional neural network.

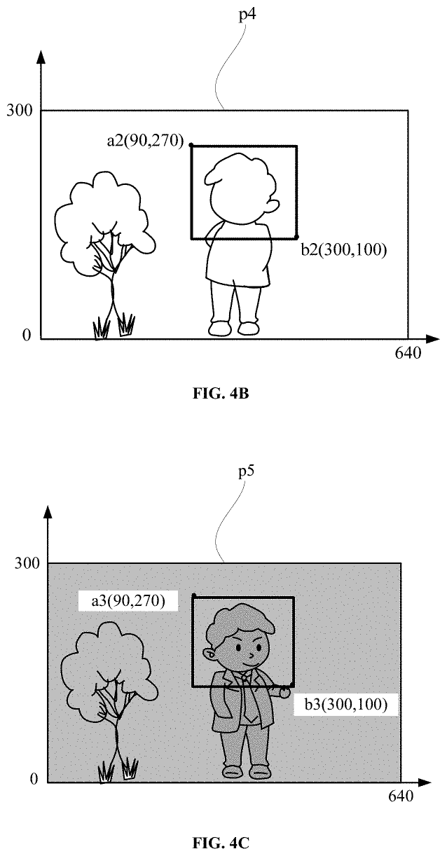

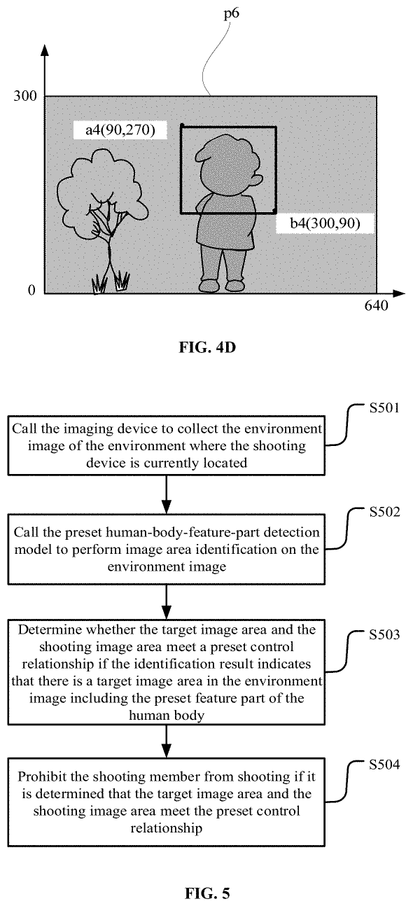

Referring to FIG. 4A to FIG. 4D, FIG. 4A is a training image p3 including the corresponding image area of the side of the head and shoulders collected under normal light, where the coordinates of a1 and b1 are the image position information of the head and shoulders in the training image p3. FIG. 4B is a training image p4 including the corresponding image area of the back of the head of shoulders collected under normal light, where the coordinates of a2 and b2 are the image position information of the head and shoulders in the training image p4. FIG. 4C is a training image p5 including the corresponding image area of the frontal head and shoulders collected under the backlight shooting scene, where the coordinates a3 and b3 are the image position information of the head and shoulders in the training image p5. FIG. 4D is a training image p6 including the image area corresponding to the back of the head of shoulders collected under normal light, where the coordinates of a3 and b3 are the image position information of the head and shoulders in the training image p6.

It can be seen that the head and shoulders detection model described above is obtained by training the initial detection model through a large number of training images including the feature parts of the head and shoulders collected in different shooting scenes (such as backlight, normal light, front of the head and shoulders, side of the head and shoulders, the head and shoulders with the lowered head, the back of the head and shoulders, etc.). On one hand, due to the use of training images of the head and shoulders feature parts at different angles under different light, the initial detection model can be trained. The trained head and shoulders detection model has high robustness for the shooting light corresponding to the input image and the shooting angle of the face corresponding to the input image, such that the front of the face, the side of the face, the lowered head, and the back of the head can be identified. On the other hand, compared with the detection of the human body, the detection of the feature parts of the head and shoulders, the head and shoulders detection model has appropriately reduced the detected image area, which not only ensures the accidental injury of the shooting device to key parts such as the face, but also helps to ensure the playability of shooting toys. This is because the image area of human body detection is relatively large. If the shooting of the entire human body is restricted, the playability of the shooting device will be seriously affected. Especially for certain shooting toys, even if the legs, stomach, and other parts of the human body is shot, the harm is relatively small.

After the shooting device calls the preset human-body-feature-part detection model to identify the image area of the environment image in the process at S202, in the process at S203, if the identification result indicates that there is a target image area in the environment image that includes the preset feature parts of the human body, the shooting member can be prohibited from shooting. In some embodiments, the preset feature parts of the human body may be a feature part of the human body. In one embodiment, the preset human-body-feature-parts may include the feature parts of head and shoulders. In addition, the preset human-body-feature-parts may also include the human body, face, and other feature parts. The preset human-body-feature-parts may have a correspondence with the human-body-feature-part detection model. In one embodiment, if the human-body-feature-part detection model can be used to detect the image area including the human body, then the preset human-body-feature-parts may include the human body. If the human-body-feature-part detection model can be used to detect the image area including a human face, then the preset human-body-feature-parts may include the human face. If the human-body-feature-part detection model can be used to detect the image area including the head and shoulders, then the preset human-body-feature-parts may include the head and shoulder feature parts.

In some embodiments, if the identification result indicates that there is a target image area including a preset feature part of the human body in the environment image, the shooting device may control the shooting member to prohibit shooting, such as prohibiting the shooting member from firing bullets. In this way, when a person is detected in the environment image, the shooting function of the shooting member in the shooting device can be actively restricted, which is beneficial in preventing the shooting member from shooting the feature parts of the human body.

In the embodiments of the present disclosure, the shooting device can call the imaging device to collect the environment image of the environment where the shooting device is currently located, and call the preset human-body-feature-part detection model to identify the image area of the environment image. If the identification result indicates that there is a target image area including a preset feature part of the human body in the environment image, the shooting device can be prohibited from shooting. By adopting the present disclosure, the shooting function of the shooting member in the shooting device can be restricted in conjunction with the image, which is beneficial in preventing the shooting member from shooting the feature parts of the human body, thereby improving the safety of the shooting device.

FIG. 5 is a flowchart of another control method based on image recognition according to an embodiment of the present disclosure. The method can be executed by a shooting device, and the method can be applied to a shoot device, the shooting device may include a shooting member and an imaging device.

In the control method based on image recognition shown in FIG. 5, in the process at S501, the shooting device may call the imaging device to collect environment image of the environment where the shooting device is current positioned, and in the process at S502, the human-body-feature-part detection model can be called to identify the image area of the environment image. For the specific implementation method of the processes at S501 and S502, reference may be made to the related description of the processes at S201 and S202, which will not be repeated here.

After the shooting device calls the preset human-body-feature-part detection model to identify the image area of the environment image, in the process at S503, if the identification result indicates that there is a target image area including a preset feature part of the human body in the environment image, whether the target image area and the shooting image area meets a preset control relationship may be determined. In some embodiments, the shooting image area may be the image area corresponding to a shooting estimation area of the shooting member in the shooting device on the environment image. In one embodiment, both the shooting member and the imaging device may be built in the shooting device, and the two may have a linkage relationship. The shooting image area may be determined based on the installation relationship between the shooting member and the imaging device. More specifically, the shooting image area may be determined based on the orientation of the imaging device compared to the shooting member, the installation distance between the shooting member, etc.

Referring to FIG. 1B and FIG. 1C, FIG. 1B includes a shooting device 102. The shooting device 102 includes an imaging device and a shooting member, and the imaging device is positioned directly above the shooting member. The installation distance between the imaging device and the shooting member is d, and the shooting device can call the imaging device to collect the environment image of the current environment. The collected environment image p1 can be as shown in FIG. 1C, and the size of the environment image p1 is 640*300. FIG. 1C includes a shooting image area 103, a center point O1 of the collected environment image p1, and a center point O2 of the shooting image area, where the coordinates of O1 are (300, 150) and the coordinates of O2 are (300, 200). It can be seen that since the shooting member is positioned directly below the imaging device, the shooting image area 103 is also directly below the environment image p1. In addition, the center point O2 of the shooting image area has the same horizontal coordinate as the center point O1 of the environment image area, and a distance dl between O1 and O2 is related to the vertical installation distance d. Alternatively, in another embodiment, when the shooting member is positioned directly above the imaging device, the shooting image area may be positioned directly above the environment image. It can be seen that the position of the shooting image area may change relative to the change of the orientation of the imaging device relative to the shooting member and the change of the installation distance d between the imaging device and the shooting member.

After the shooting device determines whether the target image area and the shooting image area meet the preset control relationship, in the process at S504, if it is determined that the preset control relationship between the target image area and the shooting image area is met, the shooting member may be prohibited from shooting.

In some embodiments, the preset control relationship described above may include an overlap relationship between the target image area and the shooting image area, a distance between the target image area and the shooting image area, and an inclusion relationship between the target image area and the shooting image area.

In one embodiment, if the identification result indicates that there is a target image area including a preset feature part of the human body in the environment image, the shooting device may determine whether the degree of overlap between the target image area and the shooting image area is greater than or equal to a preset overlap threshold. If the target image area and the shooting image area is greater than or equal to the preset overlap threshold, the relationship between the target image area and the shooting image area may be determined as meeting the preset control relationship. In some embodiments, the degree of overlap described above may refer to the ratio of the overlap between the target image area and the shooting image area to the target image area, and the preset overlap threshold may be a preset ratio threshold. For example, the preset ratio threshold may be 30%, and the area of the target image area may be 100. In this case, if the shooting device detects that the overlap area between the target image area and the shooting image area is 50, the overlap area between the target image area and the shooting image area can be calculated to be 50% of the target image area. Since 50% is greater than the preset ratio threshold of 30%, it can be determined that the target image area and the shooting image area meet the preset control relationship.

In one embodiment, if the identification result indicates that there is a target image area including a preset feature part of the human body in the environment image. The shooting device may determine whether the distance between the target image area and the shooting image area is less than or equal to a preset distance. If the distance between the target image area and the shooting image area is less than or equal to the preset distance, the relationship between the target image area and the shooting image area may be determined as meeting the preset control relationship. In some embodiments, the distance between the target image area and the shooting image area described above may be a distance between the center of the target image area and the center of the shooting image area, and the preset distance described above may be a preset distance threshold between the center of the target image area and the center of the shooting image area.

In another embodiment, the distance between the target image area and the shooting image area described above may also be a minimum edge distance between an edge of the target image area and an edge of the shooting image area. The preset distance described above may be a preset minimum edge threshold between the target image area and the shooting image area.

In one embodiment, if the identification result indicates that there is a target image area in the environment image including a preset feature part of the human body, the shooting device may determine whether the target image area is within the shooting image area. If the target image area is within the shooting image area, the relationship between the target image area and the shooting image area may be determined as meeting the preset control relationship.

Alternatively, in another embodiment, the shooting device may determine whether the shooting image area is within the target image area. If the shooting image area is within the target image area, the relationship between the target image area and the shooting image area may be determined as meeting the preset control relationship.

In the embodiments of the present disclosure, the shooting device can call the imaging device to collect the environment image of the environment where the shooting device is currently located, and call the preset human-body-feature-part detection model to identify the image area of the environment image. If the identification result indicates that there is a target image area in the environment image including a preset feature part of the human body, whether the target image area and the shooting image area meets a preset control relationship can be determined. If it is determined that the preset control relationship between the target image area and the shooting image area is met, the shooting member can be prohibited from shooting. By adopting the present disclosure, on one hand, the shooting function of the shooting member in the shooting device can be restricted, which is beneficial in preventing the shooting member from shooting the feature parts of the human body and improve the safety of the shooting device, on the other hand, the detection of the feature parts of the human body can prevent the shooting conditions from being too strict, which will reduce the playability of the shooting device.

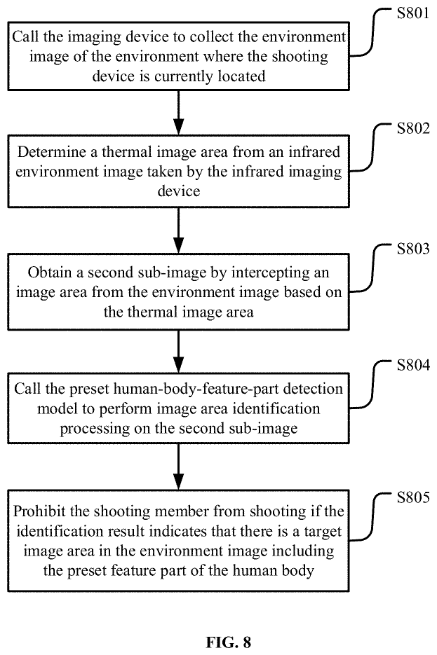

FIG. 7 is a flowchart of another control method based on image recognition according to an embodiment of the present disclosure. The method can be executed by a shooting device, and the method can be applied to a shoot device, the shooting device may include a shooting member and an imaging device.

In the control method based on image recognition shown in FIG. 7, in the process at S701, the shooting device may call the imaging device to collect environment image of the environment where the shooting device is current positioned. For the specific implementation method of the process at S701, reference may be made to the related description of the process at S201, which will not be repeated here.

After the shooting device calls the imaging device to collect the environment image of the current environment, in the process at S702, a first sub-image may be obtained by intercepting the image area from the environment image, and the preset human-body-feature-part detection model may be called to perform image area identification processing on the first sub-image. In the process at S703, the preset human-body-feature-part detection model may be called to perform full image detection and identification on the environment image.

In some embodiments, after the shooting device intercepts the image area from the environment image to obtain the first sub-image, the first sub-image can be enlarged to the target image size corresponding to the environment image to obtain a first enlarged sub-image, then the preset human-body-feature-part detection model can be called to perform image area identification processing on the first enlarged sub-image, where the target image size corresponding to the environment image may be preset. In one embodiment, the target image size may be the same size as the training image used when training the human-body-feature-part detection model, which helps to improve the accuracy of image identification of the human-body-feature-part detection model. In another embodiment, the target image size may be the same as the image size of the environment image.

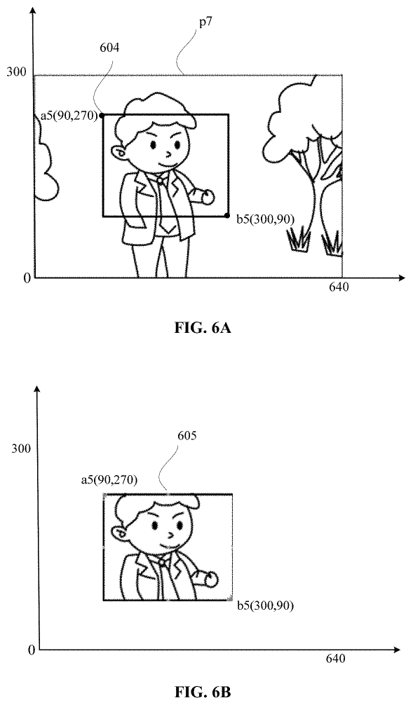

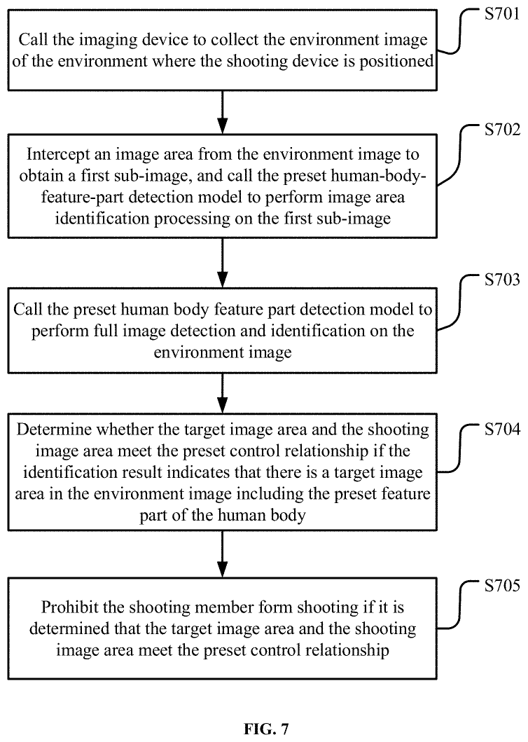

In some embodiments, the first sub-image may be obtained based on the shooting image area. In one embodiment, the first sub-image may be the image corresponding to the shooting image area. Assume that the target image size corresponding to the environment image is 640*300, as shown in FIG. 6A and FIG. 6B, the size of an environment image p7 is 640*300, the size of a shooting image area 604 is 210*180, the coordinates of the point a5 in the upper left corner of the shooting image area 604 are (90, 270), and the coordinates of the point b5 in the lower right corner of the shooting image area 604 are (300, 90). In this case, on one hand, the shooting device can intercept the image corresponding to the shooting image area from the environment image shown in FIG. 6A based on the size of the shooting image area and the coordinates of the point a5 and the point b5 to obtain a first sub-image 605 as shown in FIG. 6B. That is, the first sub-image 605 may be the image corresponding to the shooting image area 604. Further, the size of the first sub-image can be enlarged from 210*180 to 640*300 to obtain the first enlarged sub-image. The first enlarged sub-image can be input into the preset human-body-feature-part detection model, and the preset human-body-feature-part detection model can be used to perform image area identification on the first enlarged sub-image. On the other hand, the shooting device can call the human-body-feature-part detection model to perform full image detection and identification of the environment image.

In one embodiment, calling the preset human-body-feature-part detection model to perform image area identification (hereinafter referred to as the half-image identification) on the first sub-image (the process at S702), and calling the preset human-body-feature-part detection model to perform full image detection and identification on the environment image (hereinafter referred to as the full-image identification), that is, the process at S703, can be performed at the same time. When these processes are performed at the same time, the preset human-body-feature-part detection model will be called to perform image area identification on the first sub-image, and the identification result obtained can be referred to as the first identification result; and the preset human-body-feature-part detection model can be called to perform full image detection and identification on the environment image, and the identification result obtained can be called the second identification result. In this case, if it is detected that any one of the first identification result and the second identification result indicates that there is a target image area in the environment image including a preset feature part of the human body, the half-image identifications and the full-image identification may be stopped.

Alternatively, in another embodiment, the shooting device may first execute the process at S702 of calling the preset human-body-feature-part detection model to perform image area identification of the first sub-image. If the target image area including the preset feature part of the human body is not identified in the first sub-image, that is, the target image area including the preset feature part of the human body is not identified in the environment image, then the process at S703 of calling the preset human-body-feature-part detection model to perform full image detection and identification on the environment image can be performed.

In the process at S704, if the identification result indicates that there is a target image area in the environment image including a preset feature part of the human body, whether the target image area and the shooting image area meets the preset control relationship can be determined. In some embodiments, the identification result may include the result of performing the image area identification on the first sub-image (i.e., the first identification result) and/or the result of perform full image detection and identification on the environment image (i.e., the second identification result).

In one embodiment, if the shooting device not only calls the preset human-body-feature-part detection model to perform image area identification processing on the first sub-image, but also calls the preset human-body-feature-part detection model to perform full image detection and identification on the environment image, in this case, if any one of the first identification result and the second identification result indicates that there is a target image area including a preset feature part of the human body in the environment image, then the process of determining whether the target image area and the shooting image area meets the preset control relationship can be performed.

After determining whether the target image area and the shooting image area meet the preset control relationship in the process at S704, in the process at S705, if it is determined that the preset control relationship between the target image area and the shooting image area is met, the shooting member can be prohibited from shooting. For the specific implementation method of the process at S705, reference may be made to the related description of the process at S705 in the foregoing embodiment, which will not be repeated here.

In the embodiments of the present disclosure, the shooting device can call the imaging device to collect the environment image of the environment where the shooting device is current positioned, intercept the image area from the environment image to obtain the first sub-image, call the preset human-body-feature-part detection model to perform image area identification processing on the first sub-image, and call the preset human-body-feature-part detection model to perform full image detection and identification on the environment image. If the identification result indicates that there is a target image area including a preset feature part of the human body in the environment image, the shooting device can determine whether the target image area and the shooting image area meet the preset control relationship, and call the preset human-body-feature-part detection model to identify the image area of the environment image. If the identification result indicates that there is a target image area including a feature part of the human body in the environment image, the shooting member can be prohibited from shooting. By adopting the present disclosure, on one hand, the half-image identification and the full-image identification can be used to alternately detect the feature parts of the human body, which is beneficial in improving the detection efficiency of the feature parts of the human body; on the other hand, the shooting function of the shooting member in the shooting device can be restricted, which is beneficial in preventing the shooting member from shooting the feature parts of the human body and improving the safety of the shooting device.

FIG. 8 is a flowchart of another control method based on image recognition according to an embodiment of the present disclosure. The method can be executed by a shooting device, and the method can be applied to a shoot device, the shooting device may include a shooting member, an imaging device, and an infrared imaging device.

In the control method based on image recognition shown in FIG. 8, in the process at S801, the shooting device may call the imaging device to collect environment image of the environment where the shooting device is current positioned. For the specific implementation method of the process at S801, reference may be made to the related description of the process at S201, which will not be repeated here.

After the shooting device collect the environment image of the current environment, in the process at S802, a thermal image area may be determined from an infrared environment image taken by the infrared imaging device. In the process at S803, a second sub-image may be obtained by intercepting the image area from the environment image based on the thermal image area.

In some embodiments, the size of the infrared environment image and the environment image may be the same. After the shooting device determines the thermal image area from the infrared environment image taken by the infrared imaging device, it can obtain the position information of the thermal image area in the infrared environment image, and then based on the position information, the second sub-image can be obtained from the environment image to the image area with the same area as the thermal image area.

In some embodiments, the thermal image area may be a rectangular area, and the position information of the thermal image area in the infrared environment image may be the position coordinates of the upper left corner and the lower right corner of the thermal image area. For example, assume that the size of the infrared environment image and the environment image are both 640*360, the position coordinates of s point a6 in the upper left corner of the thermal image area may be (90, 300), and the position coordinates of a point b6 in the lower right corner of the thermal image area may be (30, 100). In this case, the shooting device may determine the second sub-image in the environment image. The coordinates of the upper left points a7 and a6 of the second sub-image in the environment image may be the same, and the coordinates of the lower right points b7 and b6 in the environment image may be the same.

After the shooting device obtains the second sub-image, in the process at S804, the shooting device may call the preset human-body-feature-part detection model to perform image area identification processing on the second sub-image.

In some embodiments, after the shooting device intercepts the image area from the environment image based on the thermal image area to obtain the second sub-image, the shooting device may also enlarge the second sub-image to the target image size corresponding to the environment image to obtain an enlarged second sub-image, and the preset human-body-feature-part detection model can be called to perform image area identification processing on the second enlarge sub-image. In one embodiment, the target image size may be the same size as the training image used when training the human-body-feature-part detection model, which helps to improve the accuracy of image identification of the human-body-feature-part detection model. In another embodiment, the target image size may be the same as the image size of the environment image.

After the shooting device calls the preset human-body-feature-part detection model to perform image area identification processing on the second sub-image, in the process at S805, if the identification result indicates that there is a target image area in the environment image including a preset feature part of the human body, the shooting member can be prohibited from shooting.

In some embodiments, before prohibiting the shooting member from shooting, the shooting device may determine a distance between the human body corresponding to the preset human-body-feature-part in the environment image and the shooting device. When the distance is less than or equal to a preset maximum range of the shooting device, the shooting member may be prohibited from shooting.

In some embodiments, the shooting device may calculate the distance between the human body corresponding to the preset human-body-feature-part in the environment image and the shooting device based on the ratio of the target image area to the environment image. More specifically, during the shooting process, the shooting device may obtain the focal length of the imaging device and the current focus distance. When the focal length and the focus distance of the imaging device are determined, the larger the ratio of the human body corresponding to the preset human-body-feature-part in the environment image in the screen, the shorter the distance between the human body corresponding to the preset human-body-feature-part and the imaging device. When the ratio of the target image area to the environment image is determined, the distance between the human body corresponding to the preset human-body-feature-part and the imaging device can be determined based on the ratio.

In some embodiments, the shooting device may also be pre-configured with a distance sensor. In this case, the shooting device may obtain the sensing data of the distance sensor, and obtain the distance between the human body corresponding to the preset human-body-feature-part in the environment image (hereinafter referred to as the target human body) and the imaging device based on the sensing data. In some embodiments, the distance sensor may be an infrared ranging sensor, which can sense the distance between the obstacle and the shooting device in the current environment. Since by executing the process at S805, it is determined that there is a target image area including the preset human-body-feature-part in the environment image, in this case, the human body corresponding to the preset human-body-feature-part in the environment image can be considered as one of the obstacles.

The basic principle of infrared ranging sensor may include using a luminous tube to emit infrared light, and using a photosensitive receiving tube to receive the reflected light from the object in front of the infrared ranging sensor, and determining whether there is an obstacle in front of the infrared ranging sensor based on the reflected light. The distance of the object can be determined based on the intensity of the reflected light, and its principle is that the intensity of the light received by the receiving tube can change with the distance of the reflecting object. The closer the distance, the stronger the reflected light, and the longer the distance, the weaker the reflected light. In one embodiment, the infrared ranging sensor and the imaging device may be both disposed in the shooting device, and the infrared ranging sensor can be configured to sense the distances between various obstacles in the current environment from the shooting device. That is, the sensing data of the infrared ranging sensor may include the distance data corresponding to each obstacle. In this case, the shooting device may extract the distance data of the target human body from the sensing data of the infrared ranging sensor for various obstacles based on the calibration relationship between the infrared ranging sensor and the imaging device. Further, the shooting device may obtain the distance between the target human body and the shooting device based on the distance data of the target human body.

In some embodiments, the sensing data of the infrared ranging sensor may be a distance image corresponding to the current environment, that is, a depth map. The depth map may include a plurality of pixels, and the value of each pixel may represent the distance between the obstacle corresponding to the pixel and the infrared ranging sensor, that is, each pixel may correspond to a distance data. In this case, the shooting device may obtain the image position information of the target image area in the environment image, and determine the depth area corresponding to the target image area in the depth map based on the image position information, and then adjust the depth area based on the calibration relationship between the infrared ranging sensor and the imaging device to obtain a target depth area. Further, the shooting device may determine the pixel positioned in the target depth area from all the pixels corresponding to the depth map as the target pixel, obtain the distance data of the target pixel, and obtain the distance between the target human body and the shooting device based on the distance data of the target pixel. In some embodiments, the distance data of the target pixel may be the distance data of the target human body. Alternatively, when there are a plurality of target pixels, the distance data of all target pixels can be averaged, and the distance data obtained by averaging may be the distance data of the target human body described above.

In some embodiments, the calibration relationship may indicate the installation position of the infrared ranging sensor and the imaging device, and an installation distance 11. In one embodiment, if the infrared ranging sensor is positioned directly above the imaging device at a distance 11 (11 may be greater than zero), then the shooting device may move the depth area up in the depth map by k1*11. The area obtained after the move may be the target depth area, k1 may be greater than zero, and its specific value may be preset. Alternatively, if the infrared ranging sensor is positioned directly below the imaging device at a distance 11, then the shooting device may move the depth area down in the depth map by k1*11. The area obtained after the move may be the target depth area.

In the embodiments of the present disclosure, the shooting device can call the imaging device to collect the environment image of the environment where the imaging device is currently located, determine the thermal image area from the infrared environment image taken by the infrared imaging device; intercept the image area from the environment image based on the thermal image area to obtain the second sub-image, and call the preset human-body-feature-part detection model to perform image area identification on the second sub-image. If the identification result indicates that there is a target image area including a feature part of the human body in the environment image, the shooting device can be prohibited from shooting. By adopting the present disclosure, on one hand, it is beneficial in improving the detection efficiency of the feature parts of the human body; on the other hand, the shooting function of the shooting member in the shooting device can be restricted, which is beneficial in preventing the shooting part from shooting the feature parts of the human body and improving the safety of the shooting device.

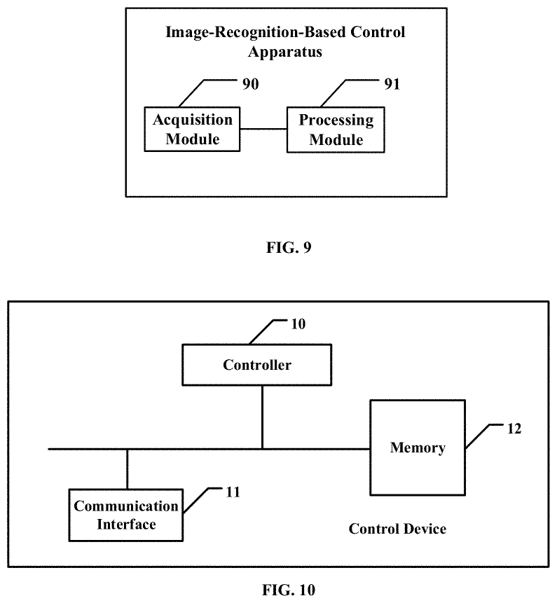

Based on the above method embodiments, an embodiment of the present disclosure further provides a control apparatus based on image recognition as shown in FIG. 9. The control apparatus can be configured in a shooting device, and the shooting device may include a shooting member and an imaging device. As shown in FIG. 9, the control apparatus includes an acquisition module 90 configured to call the imaging device to collect an environment image of the environment where the shooting device is current position; and a processing module 91 configured to call a preset human-body-feature-part detection model to perform image area identification on the environment image collected by the acquisition module 90. In addition, the processing module 91 may be further configured to prohibit the shooting member from shooting if the identification result indicates that there is a target image area including a preset feature part of the human body in the environment image.

In some embodiments, the processing module 91 may be further configured to train the initial detection model based on the training images in the sample image set and the annotation information of each training image to obtain a human-body-feature-part detection model. The sample image set may include a plurality of training image groups collected in different shooting scenes, the training images in the training image group may include image areas of the head and shoulders, and the annotation information may include the image position information of the head and shoulders in the corresponding training image.

In some embodiments, the processing module 91 may be further configured to determine whether a preset control relationship is met between the target image area and the shooting image area. The shooting image area may be the image area corresponding to the shooting estimation area of the shooting member on the environment image. If the preset control relationship is met between the target image area and the shooting image area, the shooting member can be prohibited from shooting.

In some embodiments, the processing module 91 may be further configured to determine that the target image area and the shooting image area meet the preset control relationship if the degree of overlap between the target image area and the shooting image area is greater than or equal to the preset overlap threshold; or determine that the target image area and the shooting image area meet the preset control relationship if the distance between the target image area and the shooting image area is less than or equal to the preset distance threshold; or determine that the target image area and the shooting image area meet the preset control relationship if the target image area is positioned in the shooting image area or the shooting image area is positioned in the target image area.

In some embodiments, the processing module 91 may be further configured to determine the distance between the human body corresponding to the preset human-body-feature-part in the environment image and the shooting device. When the distance is less than or equal to the preset maximum range distance of the shooting device, the process of prohibiting the shooting member from shoot can be performed.

In some embodiments, the processing module 91 may be further configured to calculate the distance between the human body corresponding to the preset human-body-feature-part in the environment image and the imaging device based on the ratio of the target image area to the environment image; or obtain the sensing data of the distance sensor, and obtain the distance between the human body corresponding to the preset human-body-feature-part in the environment image and the shooting device based on the sensing data.

In some embodiments, the processing module 91 may be further configured to intercept the image area to obtain the first sub-image and call the preset human-body-feature-part detection model to perform image area identification processing on the first sub-image; and/or call the preset human-body-feature-part detection model to perform full image detection and identification on the environment image.

In some embodiments, the processing module 91 may be further configured to enlarge the first sub-image to the size of the target image corresponding to the environment image to obtain the first enlarged sub-image, and call the preset human-body-feature-part detection model to perform image area identification processing on the first enlarged sub-image.

In some embodiments, the first sub-image can be obtained based on the shooting image area.

In some embodiments, the shooting device may further include an infrared imaging device, and the processing module 91 may be further configured to determine the thermal image area from the infrared environment image taken by the infrared imaging device, obtain a second sub-image by intercepting an image area from the environment image based on the thermal image area, and call the preset human-body-feature-part detection model to perform image area identification processing on the second sub-image.

In some embodiments, the processing module 91 may be further configured to enlarge the second sub-image to the target image size corresponding to the environment image to obtain a second enlarged sub-image, and call the preset human-body-feature-part detection model to perform image area identification processing on the second enlarged sub-image.

In some embodiments, the preset human-body-feature-part may include the head and shoulders feature parts.

For the specific implementation of each of the foregoing modules, reference may be made to the description of the related content in the embodiment corresponding to FIG. 2, FIG. 5, FIG. 7, or FIG. 8.

FIG. 10 is a control device according to an embodiment of the present disclosure. The control device can be configured in a shooting device, and the shooting device may include a shooting member and an imaging device. The control device includes a controller 10, a communication interface 11, and a memory 12, and the controller 10, the communication interface 11, and the memory 12 are connected by a bus. The memory 12 can be used to store program instructions and image data (such as environment images).

The memory 12 may include a volatile memory, such as a random-access memory (RAM). The memory 12 may also include a non-volatile memory, such as a flash memory, a solid-state drive (SSD), etc. The memory 12 may also be a double data rate synchronous dynamic random access memory (DDR SDRAM). The memory 12 may also include a combination of the types of memories mentioned above.

The memory 12 can be configured to store program instructions. The controller 10 can be configured to execute the program instructions stored in the memory. When executed by the controller 10, the program instructions can cause the controller 10 to call the imaging device to collect the environment image of the environment where the shooting device is currently located, call the preset human-body-feature-part detection model to perform image area identification on the environment image, and prohibit the shooting member from shooting if the identification result indicates that there is a target image area in the environment image including a preset feature part of the human body.

In some embodiments, the controller 10 may be further configured to determine whether a preset control relationship is met between the target image area and the shooting image area. The shooting image area may be the image area corresponding to the shooting estimation area of the shooting member on the environment image. If the preset control relationship is met between the target image area and the shooting image area, the shooting member can be prohibited from shooting.

In some embodiments, the controller 10 may be further configured to determine that the target image area and the shooting image area meet the preset control relationship if the degree of overlap between the target image area and the shooting image area is greater than or equal to the preset overlap threshold; or determine that the target image area and the shooting image area meet the preset control relationship if the distance between the target image area and the shooting image area is less than or equal to the preset distance threshold; or determine that the target image area and the shooting image area meet the preset control relationship if the target image area is positioned in the shooting image area or the shooting image area is positioned in the target image area.

In some embodiments, the controller 10 may be further configured to determine the distance between the human body corresponding to the preset human-body-feature-part in the environment image and the shooting device. When the distance is less than or equal to the preset maximum range distance of the shooting device, the process of prohibiting the shooting member from shoot can be performed.

In some embodiments, the controller 10 may be further configured to calculate the distance between the human body corresponding to the preset human-body-feature-part in the environment image and the imaging device based on the ratio of the target image area to the environment image; or obtain the sensing data of the distance sensor, and obtain the distance between the human body corresponding to the preset human-body-feature-part in the environment image and the shooting device based on the sensing data.

In some embodiments, the controller 10 may be further configured to intercept the image area to obtain the first sub-image and call the preset human-body-feature-part detection model to perform image area identification processing on the first sub-image; and/or call the preset human-body-feature-part detection model to perform full image detection and identification on the environment image.

In some embodiments, the controller 10 may be further configured to enlarge the first sub-image to the size of the target image corresponding to the environment image to obtain the first enlarged sub-image, and call the preset human-body-feature-part detection model to perform image area identification processing on the first enlarged sub-image.

In some embodiments, the first sub-image can be obtained based on the shooting image area.

In some embodiments, the shooting device may further include an infrared imaging device, and the controller 10 may be further configured to determine the thermal image area from the infrared environment image taken by the infrared imaging device, obtain a second sub-image by intercepting an image area from the environment image based on the thermal image area, and call the preset human-body-feature-part detection model to perform image area identification processing on the second sub-image.

In some embodiments, the controller 10 may be further configured to enlarge the second sub-image to the target image size corresponding to the environment image to obtain a second enlarged sub-image, and call the preset human-body-feature-part detection model to perform image area identification processing on the second enlarged sub-image.

In some embodiments, the preset human-body-feature-part may include the head and shoulders feature parts.

For the specific implementation of each of the controller 10, reference may be made to the description of the related content in the embodiment corresponding to FIG. 2, FIG. 5, FIG. 7, or FIG. 8.

A method consistent with the disclosure can be implemented in the form of computer program stored in a non-transitory computer-readable storage medium, which can be sold or used as a standalone product. The computer program can include instructions that enable a computer device, such as a personal computer, a server, or a network device, to perform part or all of a method consistent with the disclosure, such as one of the exemplary methods described above. The storage medium can be any medium that can store program codes, for example, a USB disk, a mobile hard disk, a read-only memory (ROM), a random access memory (RAM), a magnetic disk, or an optical disk.

It should be noted that the foregoing embodiments are merely intended for describing the technical solutions of the present disclosure instead of limiting the present disclosure. Although the present disclosure is described in detail with reference to the foregoing embodiments, persons of ordinary skill in the art should understand that they may still make modifications to the technical solutions described in the foregoing embodiments or make equivalent replacements to some or all technical features thereof, without departing from the scope of the technical solutions of the embodiments of the present disclosure.

What is claimed is:

1. A control method based on image recognition comprising:
calling an imaging device of a shooting device to collect an environment image of an environment where the shooting device is currently located;
calling a preset human-body-feature-part detection model to perform image area identification on the environment image to provide an identification result; and
prohibiting a shooting member of the shooting device from shooing, in response to the identification result indicating that the environment image contains a target image area including a preset human-body-feature-part.

2. The method of claim 1, before calling the preset human-body-feature-part detection model to perform image area identification on the environment image, further comprising:
training an initial detection model based on a plurality of training images in a sample image set and annotation information of each of the plurality of training images to obtain the human-body-feature-part detection model, wherein:
the sample image set includes a plurality of training image groups collected in different shooting scenes, the plurality of training images in the training image group includes image areas of head and shoulders, and the annotation information includes image position information of the head and shoulders in a corresponding training image.

3. The method of claim 1, wherein prohibiting the shooting member from shooting includes:
determining whether a preset control relationship between the target image area and a shooting image area is met, the shooting image area being an image area corresponding to a shooting estimation area of the shooting member on the environment image; and
prohibiting the shooting member from shooting if the preset control relationship between the target image area and the shooting image area is met.

4. The method of claim 3, wherein determining whether the preset control relationship between the target image area and the shooting image area is met includes:
determining the preset control relationship between the target image area and the shooting image area is met if a degree of overlap between the target image area and the shooting image area is greater than or equal to a preset overlap threshold; or
determining the preset control relationship between the target image area and the shooting image area is met if a distance between the target image area and the shooting image area is less than or equal to a preset distance threshold; or
determining the preset control relationship between the target image area and the shooting image area is met if the target image area is within the shooting image area or the shooting image area is within the target image area.

5. The method of claim 1, before prohibiting the shooting member from shooting, further comprising:
determining a distance between a human body corresponding to the preset human-body-feature-part in the environment image and the shooting device; and
triggering a process of prohibiting the shooting member from shooting if the distance is less than or equal to a preset maximum range distance of the shooting device.

6. The method of claim 5, wherein determining the distance between the human body corresponding to the preset human-body-feature-part in the environment image and the shooting device includes:
calculating the distance between the human body corresponding to the preset human-body-feature-part in the environment image and the shooting device based on a ratio of the target image area in the environment image; or
obtaining sensing data of a distance sensor, and obtaining the distance between the human body corresponding to the preset human-body-feature-part in the environment image and the shooting device based on the sensing data.

7. The method of claim 3, wherein calling the preset human-body-feature-part detection model to perform image area identification on the environment image includes:
intercepting an image area from the environment image to obtain a first sub-image, and calling the preset human-body-feature-part detection model to perform image area identification processing on the first sub-image; and/or
calling the preset human-body-feature-part detection model to perform a full image detection and identification on the environment image.

8. The method of claim 7, wherein calling the preset human-body-feature-part detection model to perform image area identification processing on the first sub-image includes:
enlarging the first sub-image to a target image size corresponding to the environment image to obtain a first enlarged sub-image; and
calling the preset human-body-feature-part detection model to perform image area identification processing on the first enlarged sub-image.

9. The method of claim 7, wherein:
the first sub-image is obtained based on the shooting image area.

10. The method of claim 1, wherein:
the shooting device further includes an infrared imaging device; and
calling the preset human-body-feature-part detection model to perform image area identification on the environment image includes:
determining a thermal image area from an infrared environment image taken by the infrared imaging device;
obtaining a second sub-image by intercepting an image area from the environment image based on the thermal image area; and
calling the preset human-body-feature-part detection model to perform image area identification processing on the second sub-image.

11. The method of claim 10, wherein calling the preset human-body-feature-part detection model to perform image area identification processing on the second sub-image includes:
enlarging the second sub-image to a target image size corresponding to the environment image to obtain a second enlarged sub-image; and
calling the preset human-body-feature-part detection model to perform image area identification processing on the second enlarged sub-image.

12. The method of claim 1, wherein:
the preset human-body-feature-part includes head and shoulders feature parts.

13. A control apparatus, configured in a shooting device, comprising:
a communication interface; and
a controller, the controller being configured to
call an imaging device of the shooting device to collect an environment image of an environment where the shooting device is currently located;
call a preset human-body-feature-part detection model to perform image area identification on the environment image to provide an identification result; and
prohibit a shooting member of the shooting device from shooing in response to the identification result indicating that the environment image contains a target image area including a preset human-body-feature-part.

14. The control apparatus of claim 13, wherein the controller is further configured to:
determine whether a preset control relationship between the target image area and a shooting image area is met, the shooting image area being an image area corresponding to a shooting estimation area of the shooting member on the environment image; and
prohibit the shooting member from shooting if the preset control relationship between the target image area and the shooting image area is met.

15. The control apparatus of claim 14, wherein the controller is further configured to:
determine the preset control relationship between the target image area and the shooting image area is met if a degree of overlap between the target image area and the shooting image area is greater than or equal to a preset overlap threshold; or
determine the preset control relationship between the target image area and the shooting image area is met if a distance between the target image area and the shooting image area is less than or equal to a preset distance threshold; or
determine the preset control relationship between the target image area and the shooting image area is met if the target image area is within the shooting image area or the shooting image area is within the target image area.

16. The control apparatus of claim 13, wherein the controller is further configured to:
determine a distance between a human body corresponding to the preset human-body-feature-part in the environment image and the shooting device; and
trigger a process of prohibiting the shooting member from shooting if the distance is less than or equal to a preset maximum range distance of the shooting device.

17. The control apparatus of claim 16, wherein the controller is further configured to:
calculate the distance between the human body corresponding to the preset human-body-feature-part in the environment image and the shooting device based on a ratio of the target image area in the environment image; or
obtain sensing data of a distance sensor and obtain the distance between the human body corresponding to the preset human-body-feature-part in the environment image and the shooting device based on the sensing data.

18. The control apparatus of claim 14, wherein the controller is further configured to:
intercept an image area from the environment image to obtain a first sub-image, and call the preset human-body-feature-part detection model to perform image area identification processing on the first sub-image; and/or
call the preset human-body-feature-part detection model to perform a full image detection and identification on the environment image.

19. The control apparatus of claim 18, wherein the controller is further configured to:
enlarge the first sub-image to a target image size corresponding to the environment image to obtain a first enlarged sub-image; and
call the preset human-body-feature-part detection model to perform image area identification processing on the first enlarged sub-image.

20. The control apparatus of claim 13, wherein:
the preset human-body-feature-part includes head and shoulders feature parts.
